(19) United States
(12) Patent Application Publication
(10) Pub. No.: US 2025/0319901 A1
(43) Pub. Date: Oct. 16, 2025

(54) AUTONOMOUS VEHICLES TRAJECTORY PLANNING SYSTEM AND METHOD

(71) Applicant: THE ROYAL INSTITUTION FOR THE ADVANCEMENT OF LEARNING / MCGILL UNIVERSITY, Montreal (CA)

(72) Inventors: Jilan SAMIUDDIN, Montreal (CA); Benoit BOULET, Boucherville (CA); Di WU, Montreal (CA)

(73) Assignee: THE ROYAL INSTITUTION FOR THE ADVANCEMENT OF LEARNING / MCGILL UNIVERSITY, Montreal (CA)

(21) Appl. No.: 19/176,349

(22) Filed: Apr. 11, 2025

Related U.S. Application Data
(60) Provisional application No. 63/633,192, filed on Apr. 12, 2024.

(51) Int. Cl. B60W 60/00; G01C 21/34

(52) U.S. Cl. CPC B60W 60/0015; G01C 21/3415; G01C 21/3453; B60W 2520/10; B60W 2520/105; B60W 2520/125; B60W 2552/10; B60W 2554/4042; B60W 2554/802

(57) ABSTRACT

An autonomous vehicle has several modules responsible for one or more of the aforementioned items, including a trajectory planner which plays a pivotal role in the safety of the vehicle, the comfort of its passengers, for respecting kinematic constraints and any applicable road constraints. A spatial-temporal graph trajectory planner generates safe and comfortable trajectories. A spatial-temporal graph uses the autonomous vehicle, its surrounding vehicles, and virtual nodes along the road. The graph is then forwarded into a sequential network to obtain the desired states. A simple behavioural layer is also presented that determines kinematic constraints for the planner and a novel potential function trains the network. The proposed planner is tested on three different complex driving tasks and the performance is compared with two frequently used methods. The planner generates safe and feasible trajectories, while achieving similar or longer distance in the forward direction and comparable comfort ride.

### CROSS-REFERENCE TO RELATED APPLICATION

This application claims the benefit of, and priority to, U.S. Provisional Patent Application No. 63/633,192, filed Apr. 12, 2024, and entitled “AUTONOMOUS VEHICLES TRAJECTORY PLANNING SYSTEM AND METHOD”, the disclosure of which is hereby incorporated by reference in its entirety.

### TECHNICAL FIELD

The technical field relates to autonomous driving, and more specifically to systems and methods for determining a trajectory of an autonomous vehicle.

### BACKGROUND

Autonomous vehicles have the potential to improve the overall transportation mobility in terms of safety and efficiency. The module which is primary responsible for planning safely the motion of the vehicle through a traffic is the trajectory planner. The trajectory planner is a vast and long-researched area using a wide variety of methods such as different optimization techniques, artificial intelligence and machine learning, as described in L. Claussmann, M. Revilloud, D. Gruyer, and S. Glaser, “A review of motion planning for highway autonomous driving,” IEEE Transactions on Intelligent Transportation Systems, vol. 21, no. 5, pp. 1826-1848, 2019, the entire disclosure of which is incorporated herein by reference. In this work, we propose a novel online trajectory planner by structuring the motion planning problem as sequences of spatial-temporal graphs passing through a sequential graph neural network architecture.

Different approaches have been undertaken by researchers for generating feasible trajectories. Sampling based planners like the Rapidly-exploring Random Tree (RRT) have also been extensively tested on automated vehicles for online path planning, for instance by S. Karaman and E. Frazzoli, “Sampling-based algorithms for optimal motion planning,” The international journal of robotics research, vol. 30, no. 7, pp. 846-894, 2011, the entire disclosure of which is incorporated herein by reference, due to ease of incorporating user-defined objectives. Another sampling based technique, state lattice, as described for instance in T. Gu, J. Snider, J. M. Dolan, and J.-w. Lee, “Focused trajectory planning for autonomous on-road driving,” in 2013 IEEE Intelligent Vehicles Symposium (IV). IEEE, 2013, pp. 547-552 and M. McNaughton, C. Urmson, J. M. Dolan, and J. W. Lee, “Motion planning for autonomous driving with a conformal spatiotemporal lattice,” in 2011 IEEE International Conference on Robotics and Automation. IEEE, 2011, pp. 4889-4895, the entire disclosures of which are incorporated herein by reference, discretizes the state space in a deterministic manner. Although the spatial-temporal version of the state lattice allows to plan with dynamic obstacles, its performance depends on sampling density making it time consuming, as shown in Y. Huang, H. Ding, Y. Zhang, H. Wang, D. Cao, N. Xu, and C. Hu, “A motion planning and tracking framework for autonomous vehicles based on artificial potential field elaborated resistance network approach,” IEEE Transactions on Industrial Electronics, vol. 67, no. 2, pp. 1376-1386, 2019, the entire disclosure of which is incorporated herein by reference. However, the resulting paths from graph search based planners and sampling based planners are usually not continuous and thus jerky, as discussed in D. González, J. Pérez, V. Milanés, and F. Nashashibi, “A review of motion planning techniques for automated vehicles,” IEEE Transactions on intelligent transportation systems, vol. 17, no. 4, pp. 1135-1145, 2015, the entire disclosure of which is incorporated herein by reference. Interpolating curve planners are also popular choices, e.g., clothoid curves as described for instance in A. Broggi, P. Medici, P. Zani, A. Coati, and M. Panciroli, “Autonomous vehicles control in the vislab intercontinental autonomous challenge,” Annual Reviews in Control, vol. 36, no. 1, pp. 161-171, 2012, polynomial curves a described for instance in P. Petrov and F. Nashashibi, “Modeling and nonlinear adaptive control for autonomous vehicle overtaking,” IEEE Transactions on Intelligent Transportation Systems, vol. 15, no. 4, pp. 1643-1656, 2014, Bezier curves as described for instance in L. Han, H. Yashiro, H. T. N. Nejad, Q. H. Do, and S. Mita, “Bezier curve based path planning for autonomous vehicle in urban environment,” in 2010 IEEE intelligent vehicles symposium. IEEE, 2010, pp. 1036-1042, etc., the entire disclosure of each of these references being incorporated herein by reference. However, these planners require global waypoints defined and can be time consuming when managing obstacles in real-time as discussed in González, op. cit. Frenet trajectory planner are also in the family of interpolating curve planners to generate optimal trajectory but utilizes the Frenet coordinate frame instead of the Cartesian coordinate frame, as described in M. Werling, J. Ziegler, S. Kammel, and S. Thrun, “Optimal trajectory generation for dynamic street scenarios in a frenet frame,” in 2010 IEEE International Conference on Robotics and Automation. IEEE, 2010, pp. 987-993, the entire disclosure of which is incorporated herein by reference. M. Geisslinger, F. Poszler, and M. Lienkamp, “An ethical trajectory planning algorithm for autonomous vehicles,” Nature Machine Intelligence, vol. 5, no. 2, pp. 137-144, 2023, the entire disclosure of which is incorporated herein by reference, use the Frenet planner to generate candidate trajectories for an ego and then select the best candidate based on five different ethical principles in line with the European Commission (EU).

Graph-based approaches are also commonly found in the literature. These approaches encompass spatial or spatial-temporal representations, whether one dimensional or hierarchical, like a tree across the feasible driving area, as discussed for instance in T. Stahl, A. Wischnewski, J. Betz, and M. Lienkamp, “Multilayer graph-based trajectory planning for race vehicles in dynamic scenarios,” in 2019 IEEE Intelligent Transportation Systems Conference (ITSC). IEEE, 2019, pp. 3149-3154, the entire disclosure of which is incorporated herein by reference. Each node of the graph has an associated cost and the graph-based algorithms seek to identify the path minimizing the cost between the adjacent nodes. Graph search based planners A* as described for instance in S. Kammel, J. Ziegler, B. Pitzer, M. Werling, T. Gindele, D. Jagzent, J. Schröder, M. Thuy, M. Goebl, F. v. Hundelshausen et al., “Team annieway's autonomous system for the 2007 darpa urban challenge,” Journal of Field Robotics, vol. 25, no. 9, pp. 615-639, 2008, the entire disclosure of which is incorporated herein by reference, hybrid A* as described for instance in M. Montemerlo, J. Becker, S. Bhat, H. Dahlkamp,

D. Dolgov, S. Ettinger, D. Haehnel, T. Hilden, G. Hoffmann, B. Huhnke et al., “Junior: The stanford entry in the urban challenge,” Journal of field Robotics, vol. 25, no. 9, pp. 569-597, 2008, the entire disclosure of which is incorporated herein by reference, and variations of these techniques have been widely used. The 2007 DARPA Urban Challenge was won by the vehicle called Boss that utilized the Anytime D* algorithm described in [15] D. Ferguson, T. M. Howard, and M. Likhachev, “Motion planning in urban environments,” Journal of Field Robotics, vol. 25, no. 11-12, pp. 939-960, 2008, the entire disclosure of which is incorporated herein by reference. In a more recent work, Z. Han, Y. Wu, T. Li, L. Zhang, L. Pei, L. Xu, C. Li, C. Ma, C. Xu, S. Shen et al., “An efficient spatialtemporal trajectory planner for autonomous vehicles in unstructured environments,” IEEE Transactions on Intelligent Transportation Systems, 2023, the entire disclosure of which is incorporated herein by reference, used hybrid A* to find collision free paths and further optimized the path using kinematic constraints. Many use one-layered graph in the spatial dimensions with lateral targets along the road, for instance X. Li, Z. Sun, D. Cao, D. Liu, and H. He, “Development of a new integrated local trajectory planning and tracking control framework for autonomous ground vehicles,” Mechanical Systems and Signal Processing, vol. 87, pp. 118-137, 2017 and X. Hu, L. Chen, B. Tang, D. Cao, and H. He, “Dynamic path planning for autonomous driving on various roads with avoidance of static and moving obstacles,” Mechanical systems and signal processing, vol. 100, pp. 482-500, 2018, the entire disclosures of which are incorporated herein by reference. Gu et al., op. cit., applies multiple layered graphs with linear edges along the road. The adjacent nodes resulting in the least cost are then used for path optimization. McNaughton et al., op. cit., explore both spatial and temporal dimensions in real-time in the search of minimal cost path in the graph. Multilayered graph-based trajectory planner is also proposed by Stahl et al., op. cit., where the planning task for a racing environment is divided into offline and online components. The offline part creates multiple drivable trajectories by connecting nodes in the graph, and then in real-time the online part picks the least expensive global state in the scene.

Artificial potential field techniques allow to define potential fields using potential functions (PFs) for obstacles, road structures and goals and then plan paths by moving in the descent direction of the field, as described in Y. Rasekhipour, A. Khajepour, S.-K. Chen, and B. Litkouhi, “A potential field-based model predictive path-planning controller for autonomous road vehicles,” IEEE Transactions on Intelligent Transportation Systems, vol. 18, no. 5, pp. 1255-1267, 2016, the entire disclosure of which is incorporated herein by reference. N. Noto, H. Okuda, Y. Tazaki, and T. Suzuki, “Steering assisting system for obstacle avoidance based on personalized potential field,” in 2012 15th International IEEE Conference on Intelligent Transportation Systems. IEEE, 2012, pp. 1702-1707, the entire disclosure of which is incorporated herein by reference generate the reference path to satisfy the dynamic constraints and to move the vehicle in the descent direction of the PFs. Rasekhipour et al., op. cit., combine the power of model predictive controller to address dynamic constraints, and, the power of PFs to address obstacles and road structures, to generate trajectories for the ego. An online motion planner for vehicle-like robots proposed by X. Chen, Z. Huang, Y. Sun, Y. Zhong, R. Gu, and L. Bai, “Online on-road motion planning based on hybrid potential field model for car-like robot,” Journal of Intelligent & Robotic Systems, vol. 105, no. 1, p. 7, 2022, the entire disclosure of which is incorporated herein by reference, use PFs to generate the initial path meeting road constraints. The path is then optimized as an unconstrained weighted objective function for curvature maintenance, obstacle avoidance, and speed profile. In our work, we propose personalized PFs for obstacle avoidance and maximum velocity keeping with priority given to the former.

The usage of machine learning for motion planning also has its fair share in the literature. I. Sung, B. Choi, and P. Nielsen, “On the training of a neural network for online path planning with offline path planning algorithms,” International Journal of Information Management, vol. 57, p. 102142, 2021, the entire disclosure of which is incorporated herein by reference, use neural networks to learn a planner online from data created using off-the-shelf path planning algorithms. The results show that the paths generated by the neural networks were smoother in contrast to the original paths. Prediction and planning are combined in Z. Huang, H. Liu, J. Wu, and C. Lv, “Differentiable integrated motion prediction and planning with learnable cost function for autonomous driving,” IEEE transactions on neural networks and learning systems, 2023, the entire disclosure of which is incorporated herein by reference, which deploys a neural network to predict future states of the surrounding vehicles (actors) and an initial strategy. These are then forwarded into a optimization-based differentiable motion planner to determine the final plan. L. Yang, C. Lu, G. Xiong, Y. Xing, and J. Gong, “A hybrid motion planning framework for autonomous driving in mixed traffic flow,” Green Energy and Intelligent Transportation, vol. 1, no. 3, p. 100022, 2022, the entire disclosure of which is incorporated herein by reference, use a hybrid approach where the behavioural learning is done using deep reinforcement learning (DRL) and the planning is done using a Frenet planner. In Á. Fehér, S. Aradi, F. Hegedüs, T. Bécsi, and P. Gáspár, “Hybrid ddpg approach for vehicle motion planning,” 2019, the entire disclosure of which is incorporated herein by reference, a Deep Deterministic Policy Gradient (DDPG) planner is presented that determines the optimal trajectory based on pre-defined initial and final states, and dynamic constraints. However, no obstacle is considered in the environment and it required 40,000 iterations before achieving a good quality trajectory. C.-J. Hoel, K. Driggs-Campbell, K. Wolff, L. Laine, and M. J. Kochenderfer, “Combining planning and deep reinforcement learning in tactical decision making for autonomous driving,” IEEE transactions on intelligent vehicles, vol. 5, no. 2, pp. 294-305, 2019, the entire disclosure of which is incorporated herein by reference, extend the AlphaGo Zero algorithm to a continuous state space domain without self-play and combined planning and learning for tactical decision making in autonomous driving. H. Krasowski, X. Wang, and M. Althoff, “Safe reinforcement learning for autonomous lane changing using set-based prediction,” in 2020 IEEE 23rd international conference on Intelligent Transportation Systems (ITSC). IEEE, 2020, pp. 1-7, the entire disclosure of which is incorporated herein by reference, proposes a safety layer in its reinforcement learning (RL) framework that pilots the exploration process by limiting actions to the safe subspace of the whole action space. These safe actions are determined by taking into account all the possible trajectories of the traffic participants.

### SUMMARY

The present disclosure proposes spatial-temporal graphs that incorporate virtual nodes positioned along the road. These virtual nodes are designed to meet the road boundary conditions as well as the kinematic constraints of the ego. The ego and its surrounding actors also are nodes in the graph. The graphs are processed through a network architecture containing sub-networks in series that generate the future plan for the ego. Furthermore, a simple behavioural layer in introduced to command the strategy of the ego for different driving tasks. The trajectory planner is tested for different driving tasks and the results obtained demonstrate better performance trade-off compared to two baselines used in this work.

Therefore, the present disclosure proposes a novel spatial-temporal graph that depicts the trajectory planning problem and incorporates road constraints and kinematic constraints, presents a neural network architecture that can process the above-mentioned graph to generate future plan for the ego, introduces personalized PFs for the architecture to learn on, and designs a simple behavioural layer for strategic purposes.

In accordance with an aspect, a method, system and computer-readable medium for determining a trajectory of an autonomous vehicle (ego) are provided. They include performing the steps of: generating a graph including: an ego node corresponding to the ego, a plurality of virtual nodes, each corresponding to a possible movement of the ego, and a plurality of ego-virtual edges, each connecting the ego node to a respective virtual node of the plurality of virtual nodes; and for a predefined number of time steps, performing the steps of: providing the graph as input to a neural network trained to generate a vector corresponding to a plurality of weights, each weight of the plurality of weights being associated to a respective virtual node of the plurality of virtual nodes, computing from the plurality of weights a vector corresponding to a movement of the ego, and updating the graph to account for a new position of the ego computed based on the movement of the ego, wherein the trajectory is defined by subsequent positions of the ego.

In accordance with another aspect, a method, system and computer-readable medium for training the neural network described above are provided. They include performing the step of: generating a plurality of driving scenarios, each driving scenario including: initial coordinates of an ego, initial coordinates of at least one actor, a set of coordinates defining lanes of a road, and a driving task; for each scenario of the plurality of driving scenarios, generating a corresponding graph; and optimizing parameters of the neural network to minimize a loss function for the plurality of driving scenarios, wherein the loss function is based at least on a safety level, wherein the safety level is computed based at least on a repulsive potential of the at least one actor with respect to the ego.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1A shows a snapshot of road presented in the Cartesian coordinate frame showing the Frenet framework formulation with respect to the reference curve (in blue).

FIG. 1B shows Frenet coordinate frame of the snapshot with the ego (blue circle), in which the new Frenet coordinate frame (black solid dashes) is with respect to the ego position.

FIG. 2 is a diagram of a method for transformations between the Cartesian and the Frenet frames to obtain trajectory, in accordance with an embodiment.

FIG. 3 is a flow diagram for the behavioural layer in accordance with an embodiment.

FIG. 4 is an illustration of a method for creating a graph in accordance with an embodiment.

FIG. 5A is an illustration of the network architecture to learn online the future trajectory of the ego, in accordance with an embodiment.

FIG. 5B is an illustration of the network architecture to learn online the future trajectory of the ego, in accordance with an embodiment.

FIG. 6 shows plots of potential functions, in accordance with an embodiment. It shows (a) a lateral potential function, and (b) a velocity potential function.

FIG. 7A shows the ego (blue rectangle) merging into highway from the start (dot) and the rectangles represent the progression of the vehicles over time spaced by 2 seconds.

FIG. 7B shows the velocity profiles of the ego and the actors for the merging task.

FIG. 8A shows the ego (in blue) taking exit and the rectangles represent the progression of the vehicles over time spaced by 2 seconds.

FIG. 8B shows the velocity profiles of the ego and the actors for the exit task.

FIG. 9 shows α_{pq} between ego p and actor q.

FIG. 10 is a table displaying the median score comparisons between the method disclosed herein and the baselines, based on 100 random scenarios for each type of traffic.

FIG. 11 is a schematic of a system for determining a trajectory of an autonomous vehicle using a neural network and for training the neural network, in accordance with an embodiment.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practised without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

One or more systems described herein may be implemented in computer program(s) executed on processing device(s), each including at least one processor, a data storage system (including volatile and/or non-volatile memory and/or storage elements), and optionally at least one input and/or output device. “Processing devices” encompass computers, servers and/or specialized electronic devices which receive, process and/or transmit data. As an example, “processing devices” can include processing means, such as microcontrollers, microprocessors, and/or CPUs, or be implemented on FPGAs. For example, and without limitation, a processing device may be a programmable logic unit, a mainframe computer, a server, a personal computer, a cloud based program or system, a laptop, a personal data assistant, a cellular telephone, a smartphone, a wearable device, a tablet, a video game console or a portable video game device.

Each program can implemented in a high-level programming and/or scripting language, for instance an imperative e.g., procedural or object-oriented, or a declarative e.g., functional or logic, language, to communicate with a computer system. However, a program can be implemented in assembly or machine language if desired. In any case, the language may be a compiled or an interpreted language. Each such computer program can be stored on a storage media or a device readable by a general or special purpose programmable computer for configuring and operating the computer when the storage media or device is read by the computer to perform the procedures described herein. In some embodiments, the system may be embedded within an operating system running on the programmable computer.

Furthermore, the system, processes and methods of the described embodiments are capable of being distributed in a computer program product including a computer readable medium that bears computer-usable instructions for one or more processors. The computer-usable instructions may also be in various forms including compiled and non-compiled code.

The processor(s) are used in combination with storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, diskettes, compact disks, tapes, chips, as examples only. The type of memory is of course chosen according to the desired use, whether it should retain instructions, or temporarily store, retain or update data. Steps of the proposed method are implemented as software instructions and algorithms, stored in computer memory and executed by processors.

In the following disclosure, various modules will be described. As can be appreciated, such modules can be implemented as part of one or more of the above-described computer program(s) and/or processing device(s). In some embodiments, the modules can be provided as part of one or more non-transitory computer-readable media containing instructions, which executed, cause a processing device to implement the functionality of the modules.

The following notations are used throughout the present disclosure.

| Symbol | Description | Symbol | Description |
|---|---|---|---|
| s, d | Longitudinal, | Vₛ, Vₐ | Longitudinal, |
| | lateral | | lateral virtual |
| | positions | | nodes |
| N_{V} | Number of | a, \ddot{s}, \ddot{d} | Acceleration and/ |
| | virtual nodes | | or deceleration |
| v, \dot{s}, \dot{d} | Velocity | J | Jerk |
| Uₒ, Uᵥ | Obstacle potential, | y | Output vector of |
| | velocity | | longitudinal and |
| | potential | | lateral positions |
| E | Ego vehicle | A | Actor vehicle |
| G | Graph | tₛ | Sampling period |
| N | Planning Horizon | N_{A} | Number of actors |
| h | Feature or node | W, B | Weights, biases |
| | embedding | | |
| p, q | Target node, neighbouring | α | Attention |
| | node | | coefficient |

Subscript/Superscript

| | | | |
|---|---|---|---|
| acc, | Acceleration , | upper, | Upper bound, |
| dec | Deceleration | lower | lower bound |
| rec, | Recommended, | long, | Longitudinal, |
| safe | safety | lat | Lateral |

### Theoretical Background

Graphs can be used as means of illustrating real-world problems. More particularly, graphs can capture the interactions between agents and how these agents evolve because of their involvement in a neighbourhood. The agents in a graph are called the nodes and the interactions between them are presented using edges. Graphs can be of two types: homogeneous and heterogeneous. Heterogeneous graphs, unlike homogeneous graphs, have nodes and/or edges that can have various types or labels associated with them, indicating their different roles or semantics. For example, in our work, the node representing the ego has four features while the nodes for the surrounding actors have two features requiring a heterogeneous graph representation to capture the interactions between them. Because of the differences in type and dimensionality, a single node or edge feature tensor is unable to accommodate all the node or edge features of the graph, as discussed in PyTorch Geometric, “Heterogeneous graph learning”, the entire disclosure of which is incorporated herein by reference. The computation of messages and update functions is conditioned on node or edge type. There are PyTorch libraries that are available to process heterogeneous graphs which are detailed in PyTorch Geometric, op. cit.

Neural networks that operate on graphs are called Graph Neural Networks (GNNs), as discussed for instance in F. Scarselli, M. Gori, A. C. Tsoi, M. Hagenbuchner, and G. Monfardini, “The graph neural network model,” IEEE transactions on neural networks, vol. 20, no. 1, pp. 61-80, 2008, the entire disclosure of which is incorporated herein by reference. For example, in node representations, the GNN maps nodes of a homogeneous graph to a matrix [symbol] , where, n is the number of nodes and m is the dimensionality of the features of the nodes. For node p, the GNN aggregates information from its neighbours (e.g., averages the messages from its neighbours) and then applies a neural network in several layers, as explained in J. Leskovec, “CS224W: Machine learning with Graphs, Stanford University”, the entire disclosure of which is incorporated herein by reference:

$${h}_{p}^{( i + 1 )} = σ ( {W}_{i} {\sum }_{q ∈ ?? ( p )} \frac{{h}_{q}^{( i )}}{\vert 𝒩 ( p ) \vert} + {B}_{i} {h}_{p}^{( i )} ) ,$$

$$∀ i ∈ \{ 0 , 1 , … , L - 1 \}$$

where, h is the embedding of a node, σ is a non-linear activation function, Wᵢ and Bᵢ are the weights and biases of the i^{th} layer, respectively, [symbol] (p) is the neighbourhood of the target node p, and L is the total number of layers.

Graph Attention Network (GAT), described for instance in P. Velickovič, G. Cucurull, A. Casanova, A. Romero,′ P. Lio, and Y. Bengio, “Graph attention networks,” arXiv preprint arXiv: 1710.10903, 2017, the entire disclosure of which is incorporated herein by reference, is a GNN that integrates attention so that the learning is focused on more relevant segments of the input. The network learns the importance (also called the attention coefficient e_{pq}) of the neighbours of a node as it aggregates information from them. The attention coefficient between the target node p and its neighbour q is computed by applying a common linear transformation W to the features (h) of both p and q, followed by a shared attentional mechanism a as follows:

$${e}_{p q} = a ( W {h}_{p} , {Wh}_{q} )$$

A single-layered feedforward neural network can be used for a in Velickovič et al., op. cit. To compare the neighbouring nodes properly, e_{pq} is normalized using the softmax function:

$${α}_{p q} = \frac{exp ( {e}_{p q} )}{{\sum }_{k ∈ N ( p )} exp ( {e}_{p k} )}$$

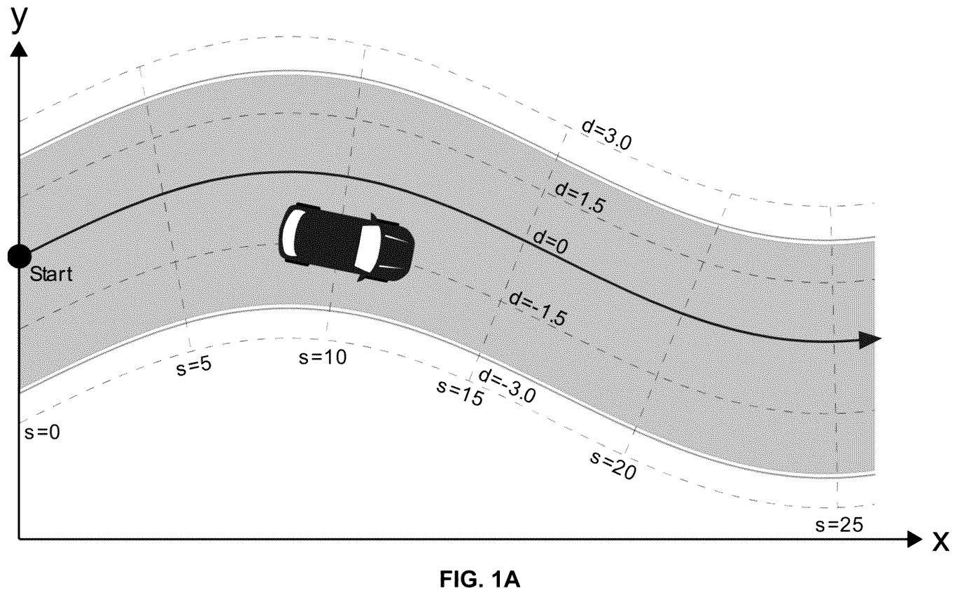

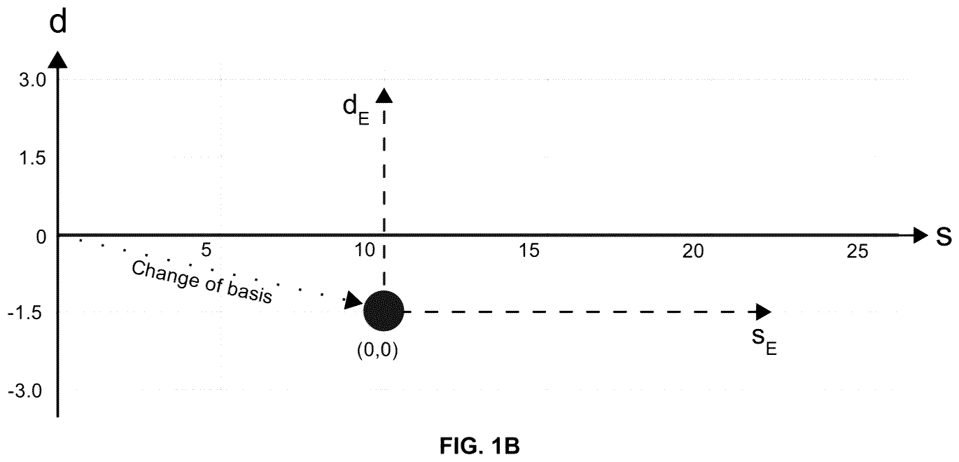

Frenet coordinate system can be used to describe the location of a point relative to a reference curve. More particularly, the Frenet coordinates s and d can represent the longitudinal and the lateral distances of the point of interest with respect to the curve from a starting point. FIG. 1A shows the Frenet coordinates inside a Cartesian coordinate frame with respect to a reference curve.

It will be appreciated that any road structure (curved, straight, etc.) in the Cartesian coordinate framework can be presented as a straight line in the Frenet coordinate framework as shown in FIG. 1B. Thus, presenting an autonomous driving task in the latter domain is much simpler. In this work, we use the Frenet coordinates as features. Furthermore, for this work, after the problem is translated in the Frenet domain, the basis of the new frame is shifted ({d,s}→{dₑ,sₑ}) with respect to the ego as shown in FIG. 1B. By applying this shift, it can be ensured that the magnitudes of the virtual nodes, as further explained below, always remain in a constrained range. Lastly, the Frenet coordinate frame also allows defining the cost of a path very effectively based on the longitudinal and the lateral displacements of the ego and the other actors.

### Trajectory Planner

A GNN-based trajectory planner utilizing a sequence of spatial-temporal graphs for trajectory planning is provided. Broadly described, the formulation of the spatial graphs consider the road constraints, the kinematic constraints of the ego and the actors surrounding it. A network architecture that processes these graphs to obtain the future trajectory is disclosed. A cost function to be minimized by the network for safety is provided to train the network. Even though the present disclosure is primarily concerned with the design of the trajectory planner module, there are other vital modules in an autonomous vehicle system. Although the design of those other modules is out of scope of the present disclosure, the skilled reader will understand that perception modules exist and can be used to receive information including as the states of the actors, road structure and the regulations are received from the perception module, and that prediction modules exist and can be used to receive the future states of the actors.

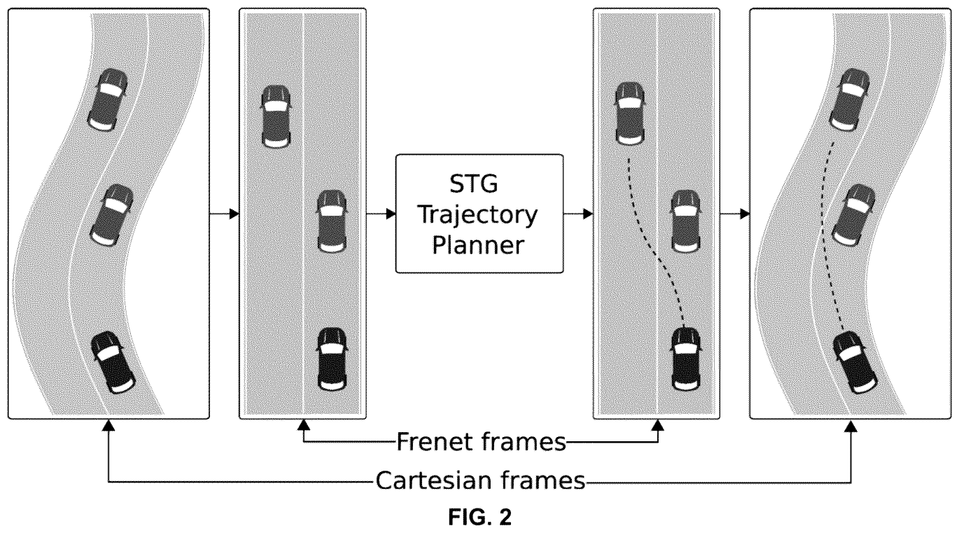

With reference to FIG. 2, an exemplary method of transformations between the Cartesian and the Frenet frames to obtain trajectory is provided. Broadly described, a scenario given in the Cartesian frame can first be transformed to the Frenet frame, which is used to solve the trajectory problem using one of the planner embodiments described below. The trajectory obtained (shown in dashed line) in the Frenet frame can then be transformed back to the Cartesian frame to get the actual trajectory for the ego.

### Behavioural Layer

The proposed framework provides a simple behavioural layer. The behavioural layer determines the strategy of the ego for different driving tasks. For example, when the ego is driving through traffic, the layer lays out the strategies to maintain safety, traffic rules and kinematic constraints. It will be appreciated that a more sophisticated behavioural layer could be used instead. Note that a lead or a rear actor in this section refers to actors which are immediate to and are in the same lane as the ego.

At first, the constraints prioritizing safety, comfort and road regulations-particularly the safety gap s_{safe}, the maximum longitudinal acceleration/deceleration aₘₐₓ, the maximum lateral acceleration/deceleration a_{max,lat} and the maximum and minimum speed limits vₘₐₓ and vₘᵢₙ, respectively—can be defined. Using these parameters, the constraints \ddot{s}_{dec,max}, \ddot{s}_{acc,max}, \dot{s}ₘₐₓ, \dot{s}ₘᵢₙ and \dot{d}ₘₐₓ presented below can then be updated.

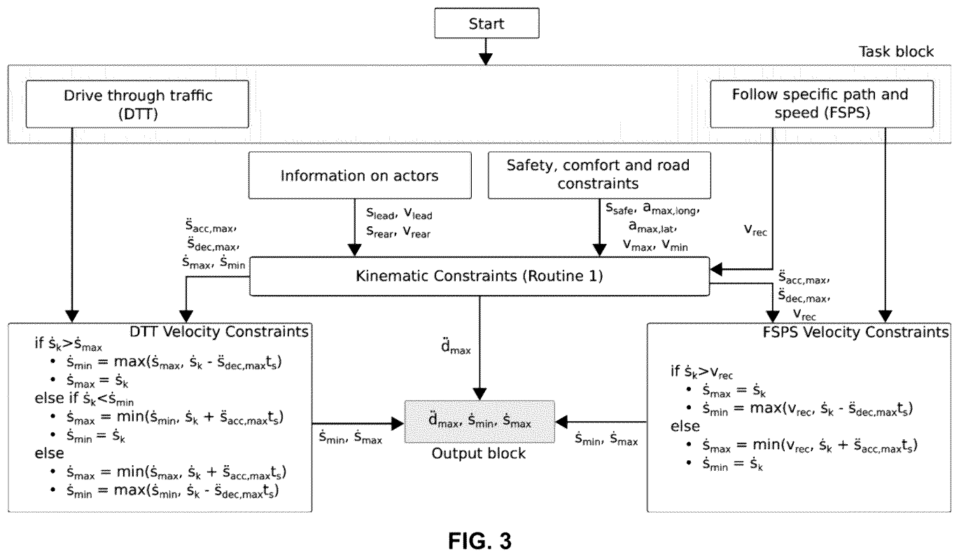

The behavioural layer, presented as a flowchart in FIG. 3, can be designed to address particular driving tasks, including “driving through traffic” (DTT) and/or “following a specific path and speed” (FSPS) tasks. In some embodiment, the following algorithm can be used for one or both of these tasks:

function Kinematic Constraints

| Inputs: | |
|---|---|
| | tₛ, s_{lead}, sᵣₑₐᵣ, v_{lead}, vᵣₑₐᵣ, α_{max,long}, vₘₐₓ, |
| | vₘᵢₙ, α_{max,lat}, v_{rec}, s_{safe}, DTT, FSPS |
| Do: | |
| 1 | if not (s_{lead} < s_{safe} or sᵣₑₐᵣ < s_{safe}): |
| 2 | |
| 3 | \ddot{s}_{acc,max} = α_{max,long} |
| 4 | \dot{s}ₘₐₓ = vₘₐₓ |
| 5 | \dot{s}ₘᵢₙ = vₘᵢₙ |
| 6 | \ddot{d}ₘₐₓ = α_{max,lat} |
| 7 | if s_{lead} < s_{safe}: |
| 8 | \ddot{s}_{dec,max} = 2α_{max,long} |
| 9 | \dot{s}ₘₐₓ = v_{lead} |
| 10 | if FSPS: |
| 11 | v_{rec} = v_{lead} |
| 12 | if sᵣₑₐᵣ < s_{safe}: |
| 13 | \ddot{s}_{acc,max} = 2α_{max,long} |
| 14 | \dot{s}ₘᵢₙ = vᵣₑₐᵣ |
| 15 | if FSPS and v_{rec} < \dot{s}ₘᵢₙ: |
| 16 | v_{rec} = \dot{s}ₘᵢₙ |
| 17 | if (s_{lead} < s_{safe} and sᵣₑₐᵣ < s_{safe}): |
| 18 | \ddot{d}ₘₐₓ = 2α_{max,lat} |
| 19 | if \dot{s}ₘᵢₙ > \dot{s}ₘₐₓ : |
| 20 | \dot{s}ₘᵢₙ = \dot{s}ₘₐₓ |

Return:

if DTT: \ddot{s}_{dec,max}, \ddot{s}_{acc,max}, \dot{s}ₘₐₓ, \dot{s}ₘᵢₙ, \ddot{d}ₘₐₓ
if FSPS: \ddot{s}_{dec,max}, \ddot{s}_{acc,max}, \ddot{d}ₘₐₓ, v_{rec}

Lines 1-6 imply that in the absence of a lead actor or a rear actor within the safety gap, the kinematic constraints should remain the same, which were determined prioritizing comfort. However, if there is a lead actor within the safety gap (line 7), then the maximum deceleration rate s″dec, max is doubled (line 8) and the maximum velocity s′max is constrained to lead actor's velocity vlead (line 9). If the task is FSPS, the recommended speed vrec is set to vlead (line 11). Similarly, if there is a rear actor within the safety gap (line 12), the maximum acceleration rate s″acc, max is doubled (line 13) and the minimum velocity s′min is constrained to rear actor's velocity vrear (line 14). With FSPS, the recommended velocity vref is set to s′min if vref<s′min (line 16). In the event that there is both a lead and a rear actor within the safety gap (line 17), the lateral acceleration d″max is doubled (line 18). Furthermore, the maximum velocity is adjusted in the event that the rear actor is moving faster than the lead actor (lines 19-20).

It will be appreciated that doubling both the lateral and longitudinal accelerations from the already given acceleration constraints is a heuristic for safety, indicating that the ego should be able to speed up its way out of danger in the event a lead or a rear actor breaches the safety gap without losing control. For example, with a higher lateral acceleration in effect, the ego can swerve away faster from the near-colliding vehicle, and this behaviour is common in human drivers [39].

### Spatial-Temporal Graphs

In some embodiments, a self-driving vehicle is configured to respect the road constraints, e.g., road boundaries, speed limit, etc., to ensure safety. In addition, it cannot violate its physical constraints, also known as the kinematic constraints, e.g., steering limits, acceleration/deceleration limits.

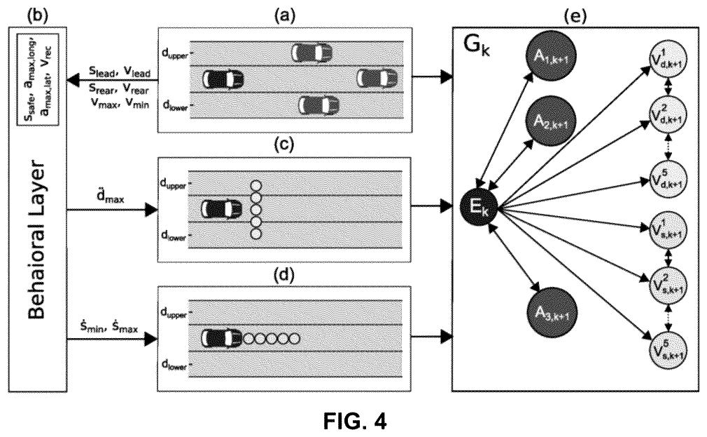

With reference to FIG. 4, in some embodiments, these constraints are incorporated in the graph. In some embodiments, the formation of the graphs requires knowledge of the future trajectories of the surrounding actors, obtained from an external module. In FIG. 4, it can be appreciated that (a) the ego (in blue) is surrounded by actors (in red), (b) the behavioural layer generates kinematic constraints for the current scenario (c) the lateral virtual nodes (in light peach) are spread out laterally along the road respecting road boundaries, (d) the longitudinal virtual nodes (in light green) are spread out longitudinally ahead of the ego along the road, and (e) formation of graph Gₖ for the given snapshot with Nᵥ=5.

An example snapshot is depicted as (a). In this snapshot, the ego is surrounded by three other actors. The ego can be presented as a node Eₖ in the graph with its longitudinal and lateral positions and velocities as features at the k^{th} step with k=0, . . . , N−1, where N is the planning horizon and k=0 denotes the initial timestamp. All of the N_{A} number of actors in a scenario are represented by nodes A_{i,k+1} with i=1, . . . , N_{A}. The future lateral and longitudinal positions of the actors at the (k+1)^{th} step are the features of their corresponding nodes. The graph can additionally include virtual nodes V, corresponding to imaginary points on the road spaced laterally or longitudinally with respect to the ego, for instance using kinematic constraints received from a behavioral layer (b), as shown in (c) and (d), respectively. In some embodiments, these virtualized nodes have only one feature: the lateral or the longitudinal spacing from the ego at k^{th} step. The lateral and the longitudinal positions can be expressed with respect to a reference path. In the present disclosure, Frenet coordinates d and s will be used for lateral displacement and longitudinal distances, respectively.

The lateral nodes can be constrained by the road boundaries and the lateral kinematic constraints, particularly the maximum lateral acceleration/deceleration \ddot{d}ₘₐₓ. At the (k+1)^{th} step, the maximum lateral velocity of the ego can be given by, for instance,

$${\dot{d}}_{max}^{k + 1} = {\ddot{d}}_{max} {t}_{s}$$

where, tₛ is the sampling period. Therefore, the above equation can impose the lateral kinematic constraints. The road constraint, i.e., d_{lower}≤d^{k+1}≤dᵤₚₚₑᵣ, where the boundary conditions d_{lower} and dᵤₚₚₑᵣ can constrain the ego to stay on the road, and can for instance be imposed using the following:

$${d}_{max}^{k + 1} = min ( {d}_{upper} , {d}^{k} + {\dot{d}}_{max}^{k + 1} {t}_{s} )$$

$${d}_{min}^{k + 1} = max ( {d}_{lower} , {d}^{k} - {\dot{d}}_{max}^{k + 1} {t}_{s} )$$

$$where , {d}_{max}^{k + 1} and {d}_{min}^{k + 1}$$

are the maximum and the minimum lateral distances that the ego can move. Given the number of lateral virtual nodes Ny, the nodes are layered laterally with equal spacing as follows:

$${V}_{d} = {[ \begin{matrix}{d}_{min}^{k + 1} & {d}_{min}^{k + 1} + {δ}_{d} & {d}_{min}^{k + 1} + 2 {δ}_{d} & … & {d}_{max}^{k + 1} - {δ}_{d} & {d}_{max}^{k + 1}\end{matrix} ]}^{T} ∈ {ℝ}^{{N}_{V}}$$

where, δ_{d} is the spacing defined by

$${δ}_{d} := \frac{( {d}_{max}^{k + 1} - {d}_{min}^{k + 1} )}{( {N}_{V} - 1 )} .$$

For the longitudinal nodes, the kinematic constraints can be applied are as follows: the maximum longitudinal velocity \dot{s}ₘₐₓ, the minimum longitudinal velocity \dot{s}ₘᵢₙ, the maximum acceleration \ddot{s}_{acc,max} and the maximum deceleration \ddot{s}_{dec,max}. Then, at the (k+1)^{th} step, the maximum and the minimum longitudinal velocities of the ego,

$${\dot{s}}_{max}^{k + 1} and {\dot{s}}_{min}^{k + 1}$$

respectively, can be generated by the behavioural layer as defined above. Next, the maximum and the minimum longitudinal distances the ego can traverse can be defined for instance by

$$\begin{matrix}{s}_{max}^{k + 1} = {s}^{k} + {\dot{s}}_{max}^{k + 1} {t}_{s} \\ {s}_{min}^{k + 1} = {s}^{k} + {\dot{s}}_{min}^{k + 1} {t}_{s}\end{matrix} ,$$

respectively. For Nᵥ number of virtual longitudinal nodes, the longitudinal layering of these nodes can be defined similarly as above:

$${V}_{s} : = {[ {s}_{min}^{k + 1} {s}_{min}^{k + 1} + {δ}_{s} {s}_{min}^{k + 1} + 2 {δ}_{s} ⋯ {s}_{max}^{k + 1} - {δ}_{s} {s}_{max}^{k + 1} ]}^{T} ∈ {ℝ}^{{N}_{V}}$$

where, δₛ is the equal spacing between the adjacent nodes defined by

$${δ}_{s} = \frac{( {s}_{max}^{k + 1} - {s}_{min}^{k + 1} )}{( {N}_{V} - 1 )}$$

After all the nodes (Eₖ, A_{i,k+1}, V^{S} and V^{d}) have been defined, the graph Gₖ is formed (e). In some embodiments, the edges between Eₖ and A_{i,k+1} are bidirectional, signifying the “interactions” between the ego and the other actors—the edge features can include the Euclidean distances between the ego and the corresponding actors. The edges between the ego and the virtual nodes can be unidirectional (E to V^{s} and V^{d}) signifying the transition from k^{th} to (k+1)^{th} step (the temporal aspect of the graph itself). Thus, the edge attribute for the edges between E and, V^{s} and V^{d}, can be set to be the sampling period tₛ. The lateral virtual nodes can be connected by bidirectional edges to their adjacent nodes with each edge attribute being the corresponding lateral distance between the corresponding nodes. The interactions between the longitudinal nodes are formulated in the same manner.

### STG Network Architecture

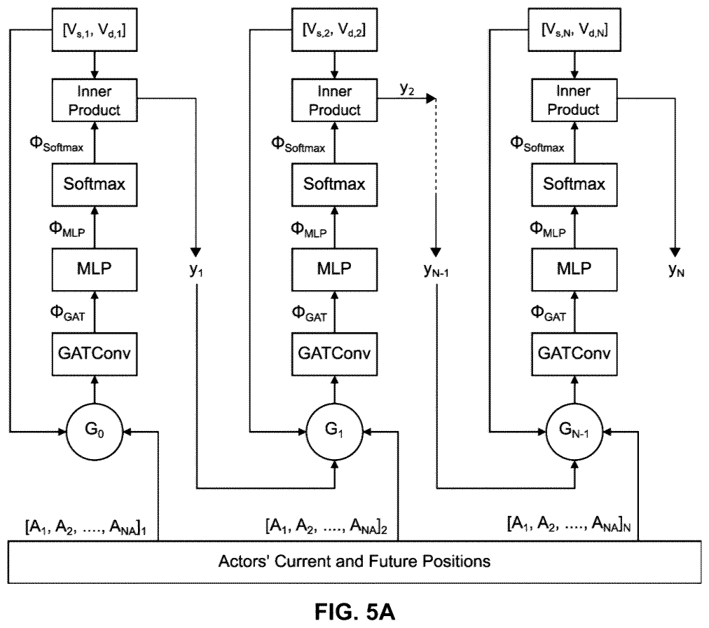

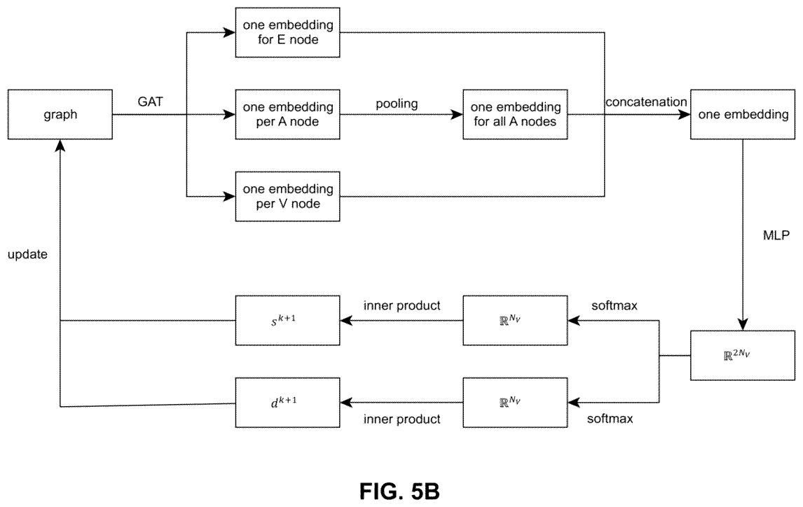

The graph Gₖ that represents the snapshot of the ego's surrounding at the k^{th} step can be processed to identify the position of the ego at the (k+1)^{th} step. With reference to FIG. 5A, an exemplary framework for processing a graph is provided. At first, Gₖ can be passed through a GAT network that generates an embedding for each of the nodes. Since Gₖ is a dynamic graph due to the varying number of actors around the ego, the direct output of the GAT network is pre-processed before passing into the multilayer perceptron (MLP) decoder.

$${Φ}_{GAT} = concat ( {Φ}_{GAT}^{E} , {Φ}_{GAT}^{{V}_{s}} , {Φ}_{GAT}^{{V}_{d}} , {Φ}_{GAT}^{A} )$$

where,

$${Φ}_{GAT}^{E} , {Φ}_{GAT}^{{V}_{s}} , {Φ}_{GAT}^{{V}_{d}} , and {Φ}_{GAT}^{A}$$

are the node embeddings of the ego, the longitudinal virtual nodes, the lateral virtual nodes and the actors nodes, respectively, generated by the GAT convolution network with

$${Φ}_{GAT}^{A} = {Φ}_{GAT}^{{A}_{1}} + {Φ}_{GAT}^{{A}_{2}} + ⋯ + {Φ}_{GAT}^{{A}_{{N}_{A}}}$$

where,

$${Φ}_{GAT}^{{A}_{i}}$$

is the embedding or the i^{th} actor. The equation above is referred to as graph pooling in the literature and pooling based on the sum is often adequate for applications involving small graphs as used in the present disclosure, see W. L. Hamilton, Graph representation learning. Morgan & Claypool Publishers, 2020, the entire disclosure of which is incorporated herein by reference. With Φ_{GAT} as the input, the MLP decoder outputs Φ_{MLP}∈ [symbol] . Then the softmax function S is used to normalize Φ_{MLP} as follows:

$${Φ}_{Softmax}^{d} = S ( {Φ}_{MLP}^{1 : {N}_{V}} ) ∈ {ℝ}^{{N}_{V}}$$

$${Φ}_{Softmax}^{s} = S ( {Φ}_{MLP}^{{N}_{V} + 1 : 2 {N}_{V}} ) ∈ {ℝ}^{{N}_{V}}$$

Finally, the virtual lateral and longitudinal nodes are weighted using

$${Φ}_{Softmax}^{d} and {Φ}_{Softmax}^{s}$$

to get the output

$$\begin{matrix}{y}_{k + 1} & = [ 〈 {Φ}_{Softmax}^{s} , {V}_{s} 〉 , 〈 {Φ}_{Softmax}^{d} , {V}_{d} 〉 ] \\ & = [ {s}^{k + 1} , {d}^{k + 1} ] ∈ {ℝ}^{2}\end{matrix} ,$$

where the operator [symbol] [symbol] represents the inner product. yₖ₊₁ is then utilized to obtain Gₖ₊₁ and the same routine is followed to obtain yₖ₊₂ and so.

With reference to FIG. 5B, another exemplary framework for processing a graph is provided. Initially, the graph that represents the snapshot of the ego's surroundings at the k^{th} step is processed by a GAT trained to generate vectorial embeddings for each node. This results in a number of embeddings being generated, e.g., one for the ego (E) node, one per virtual (V) node, and if applicable one per actor (A) node. The graph can include one E node, a predetermined number of V nodes, but an arbitrary and variable number of A nodes, depending on the number of actors around the ego. To obtain a predetermined number of embeddings, the embeddings corresponding to the A node(s) can be processed through a pooling layer, resulting in only one embedding corresponding to all the A nodes. The E embedding, the A embedding and the V embeddings can then be concatenated to obtain a single vector suitable for use as input to a multilayer perceptron (MLP). The MLP outputs a vector of weights including one weight for each V node. In some embodiments, the graph includes N_{V} lateral virtual nodes and N_{V} longitudinal virtual nodes, such that the output of the MLP is a 2N_{V}-dimensional vector, i.e., is in [symbol] . This output vector can be separated in two vectors in [symbol] , one corresponding to weights of the lateral virtual nodes and the other corresponding to weights of the longitudinal virtual nodes. A softmax function can then be applied to both vectors, resulting in two normalized weights vectors, i.e. comprising weights between 0 and 1 and having a sum of 1. The inner product of the normalized weight vector of the lateral virtual nodes and of the coordinates associated with these nodes can be computed to obtain the new lateral position at time k+1, d^{k+1}, and the inner product of the normalized weight vector of the longitudinal virtual nodes and of the coordinates associated with these nodes can be computed to obtain the new longitudinal position at time k+1, s^{k+1}. These new positions can then be used to update the graph. This process can be repeated for a predetermined number of times, or until a predetermined condition is met.

### Potential Functions

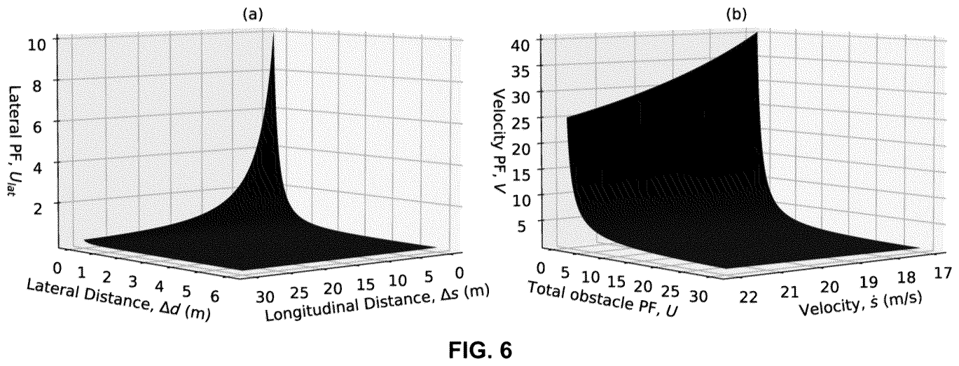

Training a neural network model can include backpropagating a loss function. Labelled trajectory data may not be available, creating a need for a self-supervised training method. With reference to FIG. 6, potential functions (PFs) of the obstacles that determine the safety of the ego for a given trajectory are provided and can be used to train the model instead of a traditional loss function. The obstacle PF can be configured to have maximum value at its position to repel the ego.

For an actor longitudinally and laterally distanced from the ego by Δs and Δd, respectively, the following longitudinal and the lateral potential functions can be applied:

$${U}^{long} : = \frac{{b}_{1}}{{( {b}_{2} Δ s + {ε}_{1} )}^{2}}$$

$${U}^{lat} : = \frac{{b}_{3} {U}^{long}}{{( {b}_{4} Δ d + {ε}_{1} )}^{2}}$$

respectively, where b₁, b₂, b₃, b₄, and ε₁ are constants. In some embodiments, b₁, b₂, b₃ and/or b₄ are learnt parameters. The U^{long} equation above simply indicates that maintaining a larger longitudinal distance alone is safer. However, safety with respect to lateral distance alone may not be sufficient. An actor maintaining a particular lateral distance from the ego at a very close proximity in terms of the longitudinal distance can possess higher risk than an actor maintaining the same lateral distance but further away longitudinally. The U^{lat} equation above (a) accounts for this phenomenon. For N_{A} number of actors surrounding the ego, the total potential function of the obstacles Uₒ can be determined as follows:

$${U}_{o} : = {\sum }_{i = 1}^{{N}_{A}} {U}_{i}^{lat}$$

It can be appreciated that, when the ego is driving through a traffic, the planner network may slow the ego so that the surrounding actors can pass by suggesting a lower risk score. However, this may be considered an ineffective way of solving for the trajectory plan. In some embodiments, a potential function of velocity Uy (b) is introduced:

$${U}_{v} : = {{c}_{1} ( \frac{{c}_{2}}{{U}_{o} + {ε}_{2}} )}^{{\dot{s}}_{max} / \dot{s}}$$

where c₁, c₂, and ε₂ are constants. In some embodiments, c₁ and/or c₂ are learnt parameters. The equation above implies that lower velocities should have higher potential when the risk is lower, i.e., Uₒ is lower. Thus, the velocity PF has its maximal value when the risk is the lowest and the ego is traveling at the minimum velocity. On the other hand, when U, is higher, the velocity PF is minimum since safety is a higher priority. Finally, the total potential (i.e., the “loss”) backpropagated into the network can be given by

$${U}_{total} = {\sum }_{k = 0}^{N} ( {U}_{o}^{k + 1} + {U}_{v}^{k + 1} )$$

### System

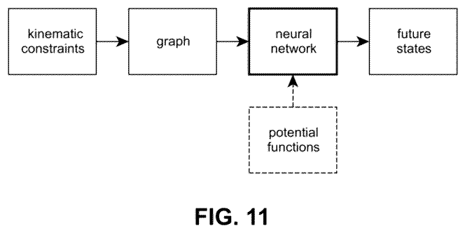

With reference to FIG. 11, an exemplary system for determining a trajectory of an autonomous vehicle using a neural network and for training the neural network is shown. The system includes a trajectory determination module configured to obtain kinematic constraints as described above. The kinematic constraints and information regarding the ego, surrounding actors and/or a road are used to build a graph. The graph is then provided as input to a neural network trained to produce future states corresponding to a trajectory for the ego as an output. In some embodiments, potential functions are used in lieu of a loss function for training the neural network, for instance based on randomly generated driving scenarios. The system can further include a controller configured to provide control signals to an autonomous vehicle to drive the autonomous vehicle according to the trajectory that is output by the neural network.

### Experimental Results

### Driving Tasks

Some autonomous driving tasks were defined to evaluate the performance of the disclosed planner. These tasks vary in complexity, e.g., vehicle following and lane keeping are on the simpler side of the spectrum, whereas, merging, driving through traffic are at the other end, as discussed for instance in S. Aradi, “Survey of deep reinforcement learning for motion planning of autonomous vehicles,” IEEE Transactions on Intelligent Transportation Systems, vol. 23, no. 2, pp. 740-759, 2020, the entire disclosure of which is incorporated herein by reference. Often, simpler tasks are sub-tasks of more complex tasks. Particularly, three complex problem statements are defined-vehicle following and lane keeping are sub-tasks of the defined problems.

### Driving Through Traffic

Aradi, op. cit., suggests that driving through traffic is the most complicated setup to test a planner. Although this task is scalable, the task was limited to highway driving. Three different densities—low, medium, and high—of traffic scenarios (100 for each) were generated using the SL2015 model of SUMO (Simulation of Urban Mobility) simulator described in P. A. Lopez, M. Behrisch, L. Bieker-Walz, J. Erdmann, Y.-P. Flotterod, R. Hilbrich, L. Lücken, J. Rummel, P. Wagner, and E. Wießner, “Microscopic traffic simulation using sumo,” in 2018 21st international conference on intelligent transportation systems (ITSC). IEEE, 2018, pp. 2575-2582, the entire disclosure of which is incorporated herein by reference. The low-density traffic scenario consists of 1-5 actors, the medium density traffic scenarios consist of 10-14 actors surrounding the ego, and the high ones consist of 15-20 actors surrounding the ego. The actors are set to respect the speed limits of the road. Once the traffic is generated, an agent from the scene is randomly selected to play the role of the ego while the trajectories of other agents remain unchanged. In this task, the ego has to plan a safe trajectory for a 5-second horizon with 0.1 second sampling time.

### Merging

In this task, the ego (driving at 50 km/h) has to merge to a highway and its lane ends in approximately 100 m. The suggested speed to enter the merging lane is set at 60 km/h. There is an actor approaching with a speed of 70 km/h in the merging lane of the highway. There is another actor in the adjacent lane driving at 75 km/h.

### Taking an Exit

The ego currently driving at 80 km/h has to take an exit with the recommended speed of 50 km/h. There is an actor approximately 25 m ahead of it driving at 55 km/h. In the course of time, the actor also takes the exit reducing its speed to the recommended speed. Another actor is driving in the adjacent lane at 75 km/h which does not take the exit.

### Baselines

Two baselines are used in this paper to assess and compare our proposed technique. The kinematic constraints used in both the baselines are the same used in the proposed method.

SL2015 from SUMO is used as the first baseline. The SL2015 model is a lane-changing behaviour model used to replicate real-world lane changing maneuvers in a traffic simulation. The model allows to define kinematic constraints such as the maximum lateral and longitudinal speeds. The model makes lane-changing decisions based on several factors such as the difference between the current and the desired speeds, cooperation between the driving agents, and the safety gap in the current lane. The data generated using the model already defines the trajectory of the randomly chosen agent as the ego. Thus, the trajectory not only respects the kinematic constraints, but also mimics cooperative behaviour with other actors on the road to maintain safety.

Next, the Frenet path planner from MATLAB (MFP), The MathWorks Inc., “Navigation toolbox version: 2.3 (r2022b),” 2022, the entire disclosure and source code of which are incorporated herein by reference, is used. It generates multiple candidate trajectories using fourth or fifth-order polynomials relative to the reference path. The candidates are then pruned by checking for kinematic constraints. Next, the trajectories are assessed for collision against the predicted motions of the surrounding actors and the colliding ones are eliminated. Finally, the cost of the remaining trajectories are measured and the least expensive trajectory is selected. The Uₜₒₜₐₗ equation presented above is used for measuring the cost.

### Evaluation Metrics

The trajectory qualities are evaluated in terms of safety, comfort and the longitudinal distance travelled. Safety is assessed by the proposed risk score shown in the U, equation presented above as follows:

$$Risk = \frac{1}{T} {\int }_{0}^{T} {U}_{o} ( t ) dt ,$$

where, T is the planning horizon in seconds. Minimum jerk—the time rate of change in acceleration—reflects maximal smoothness, and thus, discomfort score can be defined using integrated absolute jerk as defined in N. Hogan and D. Sternad, “Sensitivity of smoothness measures to movement duration, amplitude, and arrests,” Journal of motor behaviour, vol. 41, no. 6, pp. 529-534, 2009, the entire disclosure of which is incorporated herein by reference:

$$Discomfort = \frac{1}{T} {\int }_{0}^{T} \vert J ( t ) \vert dt ,$$

$$where , J = \sqrt{{J}_{long}^{2} + {J}_{lat}^{2}}$$

is the total jerk experienced in the trajectory in both longitudinal and lateral directions. The longitudinal distance is extracted from the trajectory itself.

### Experimental Results

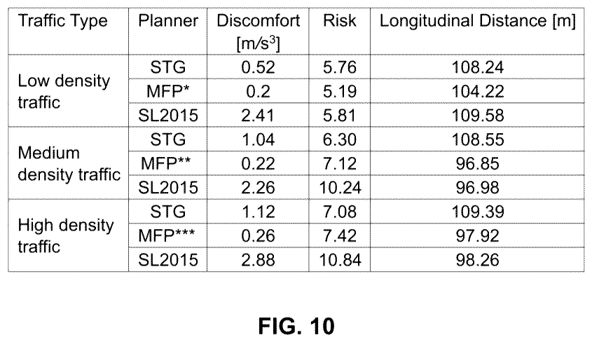

For the task of driving through medium and high density traffics, our STG planner achieved 100% success rate in planning feasible trajectories, i.e., trajectories that do not cause collision and do not violate the kinematic constraints. However, MFP failed to find feasible trajectories in 27%, 29%, and 33% of the scenarios with low, medium, and high traffics, respectively. The SUMO2015 model being the basis to generate the trajectories, does not account for any failure. FIG. 10 shows the performance comparisons between the three planners for the driving through traffic task. The median score is presented for each of the metrics as it defines the central tendency. Note that the results for MFP shown in the table include only the scenarios where it succeeded.

For all types of traffics, MFP generates the most comfortable trajectories and the proposed planner stands second in the same aspect. However, the primary objective of a planner is the ability to find a feasible path and our proposed STG planner demonstrates 100% success rate in planning in contrast to MFP. In low-density traffic scenarios, MFP performs the best in terms of risk, while SL2015 performs the best in terms of longitudinal distance travelled. However, STG achieves better risk score than SL2015 and better longitudinal distance travelled than MFP for the same traffic. The score for medium and high density traffic shows that our planner not only achieves more longitudinal distance, but also safer trajectories. MFP generates trajectories that are the shortest in terms of longitudinal distance while SL2015 generates trajectories that are the least safe.

Median score comparisons (best score in bold) between the proposed and the baselines (100 random scenarios for each type of traffic) [tab: Performance-comparison]

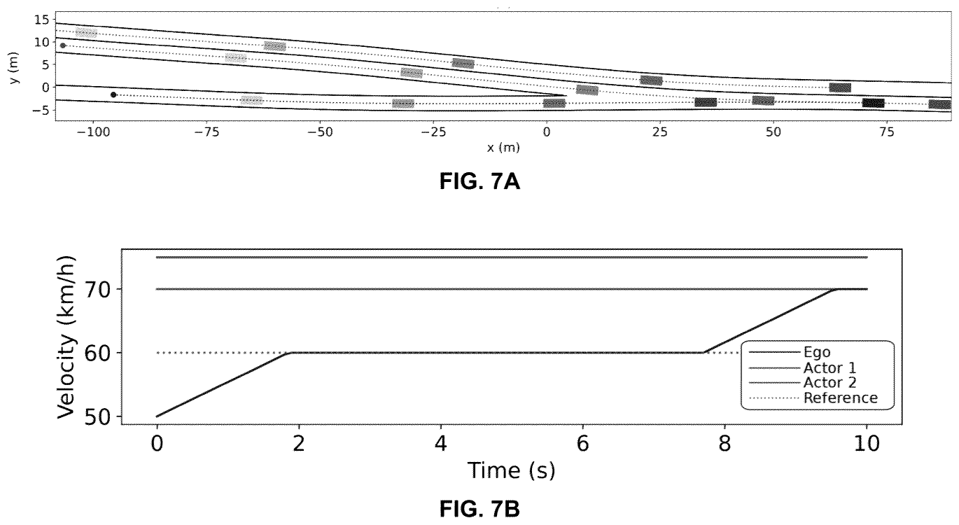

FIGS. 7A and 7B shows the performance of STG in the merging task. The velocity profile shows that it accelerates to reach the recommended speed (60 km/h) to merge. It continues with the speed until it gets behinds a lead actor (in green) and starts following it effectively.

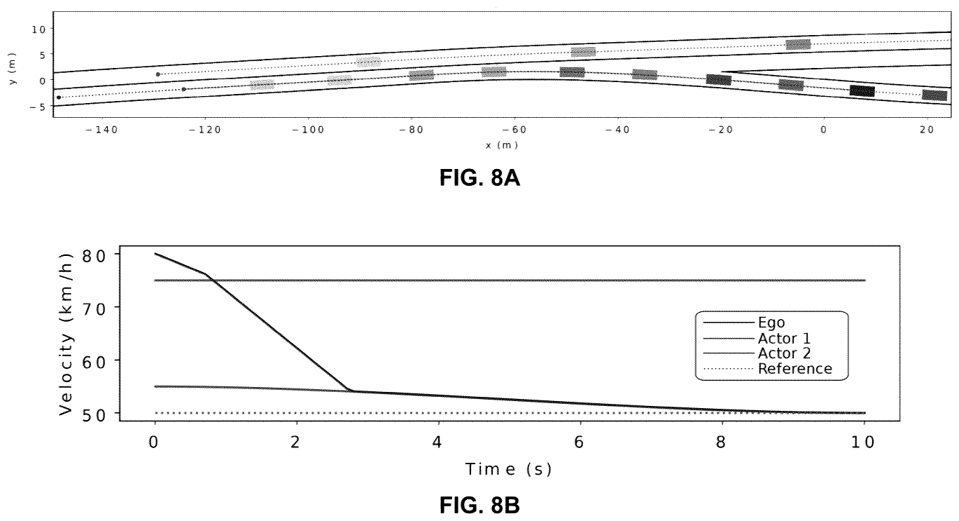

In the task of taking an exit, STG generates a safe trajectory as well as shown in FIGS. 8A and 8B. The ego starts to slow down but finds a lead actor (in green also taking the exit) and then follows it quite efficiently to take the exit. In both the above two tasks, STG demonstrates its efficacy in the following two sub-tasks: vehicle-following and lane-keeping.

### Interpretability

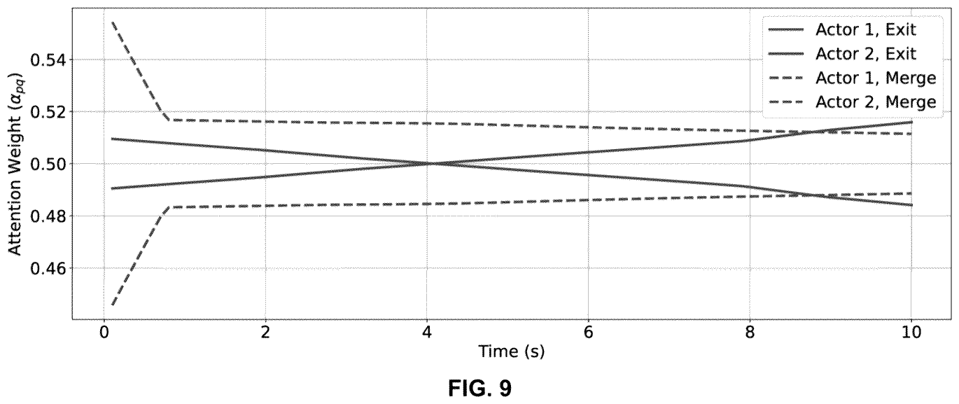

The trained GAT network encapsulates the interactions between the nodes with an attention mechanism as explained above. FIG. 9 shows the attention in the α_{pq} equation presented above evolving over time between the ego and the actors in the tasks defined above. In the merging task, it can be seen that since both the actors are closing in and remain close, their attention values tend to converge towards each other. In the other task of taking an exit, the attention of the actor taking the exit ahead of the ego increases while the attention of the actor not taking the exit decreases. While it is difficult to explain the magnitude of these attention values, it is rather intuitive that the ego should have increasing focus on the actor taking exit along with it than the one going in another direction.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A method for determining a trajectory of an autonomous vehicle (ego), the method comprising:
generating a graph comprising:
an ego node corresponding to the ego,
a plurality of virtual nodes, each corresponding to a possible movement of the ego, and
a plurality of ego-virtual edges, each connecting the ego node to a respective virtual node of the plurality of virtual nodes; and
for a predefined number of time steps, performing the steps of:
providing the graph as input to a neural network trained to generate a vector corresponding to a plurality of weights, each weight of the plurality of weights being associated to a respective virtual node of the plurality of virtual nodes,
computing from the plurality of weights a vector corresponding to a movement of the ego, and
updating the graph to account for a new position of the ego computed based on the movement of the ego,
wherein the trajectory is defined by subsequent positions of the ego.

2. The method of claim 1, wherein the graph further comprises:
at least one actor node corresponding to at least one actor; and
at least one ego-actor edge, each connecting the ego node to a respective actor node of the at least one actor node.

3. The method of claim 1, wherein the plurality of virtual nodes comprise:
a plurality of lateral nodes, each corresponding to a possible lateral movement of the ego; and
a plurality of longitudinal nodes, each corresponding to a possible longitudinal movement of the ego.

4. The method of claim 1, further comprising obtaining a set of kinematic constraints for the ego.

5. The method of claim 4, wherein the set of kinematic constraints comprises at least one of:
an updated maximum longitudinal acceleration;
an updated maximum longitudinal deceleration;
a maximum longitudinal speed;
an updated minimum longitudinal speed;
an updated maximum lateral acceleration; and
an updated recommended speed.

6. The method of claim 4, wherein the set of kinematic constraints is computed based on at least one of:
a lead actor gap;
a rear actor gap;
a lead actor velocity;
a rear actor velocity;
a maximum longitudinal acceleration;
a maximum speed;
a minimum speed;
a maximum lateral acceleration;
a recommended velocity;
a recommended gap; and
an indication of whether the ego is driving through traffic and/or the ego is following a specific path and speed.

7. The method of claim 4, wherein the plurality of virtual nodes are defined based on the set of kinematic constraints.

8. The method of claim 1, wherein the neural network comprises:
an encoder trained to input the graph and output an embedding of a predefined size; and
a decoder trained to input the vector and output the plurality of weights.

9. The method of claim 8, wherein the graph further comprises:
at least one actor node corresponding to at least one actor; and
at least one ego-actor edge, each connecting the ego node to a respective actor node of the at least one actor node, and
wherein the encoder comprises:
a graph neural network trained to input the graph and output a plurality of embeddings, comprising an embedding Φ^{E} corresponding to the ego node, a set of embeddings Φ^{A}^{ᵢ} corresponding to the at least one actor node, and a set of embeddings Φ^{V}^{ᵢ} corresponding to the plurality of virtual nodes;
a pooling layer configured to aggregate the set of embeddings Φ^{A}^{ᵢ}, generating a pooled embedding Φ^{A}; and
a concatenation layer configured to concatenate Φ^{E}, Φ^{A} and Φ^{V}^{ᵢ}.

10. The method of claim 1, wherein computing the new position of the ego is based at least on an inner product of a subset if weights from the plurality of weights associated to a respective subset of virtual nodes of the plurality of virtual nodes.

11. The method of claim 10, wherein the plurality of virtual nodes comprise:
a plurality of lateral nodes, each corresponding to a possible lateral movement of the ego; and
a plurality of longitudinal nodes, each corresponding to a possible longitudinal movement of the ego, and
wherein computing the new position of the ego consists in:
computing an inner product of all weights from the plurality of weights associated to the plurality of lateral nodes; and
computing an inner product of all weights from the plurality of weights associated to the plurality of longitudinal nodes.

12. The method of claim 1, wherein the neural network is trained self-supervisedly based on a generated plurality of driving scenarios and a loss function based at least on an automated assessment of a safety level.

13. The method of claim 12, wherein each driving scenario comprises:
initial coordinates of an ego;
initial coordinates of at least one actor;
a set of coordinates defining lanes of a road; and
a driving task,
the method further comprising:
for each scenario of the plurality of driving scenarios, generating a corresponding graph; and
optimizing parameters of the neural network to minimize the loss function for the plurality of driving scenarios, wherein the safety level is computed based at least on a repulsive potential of the at least one actor with respect to the ego.

14. The method of claim 13, wherein the driving task comprises at least one of:
driving through traffic;
merging; and
taking an exit.

15. The method of claim 13, wherein the loss function is further based on a velocity of the ego that optimizes the safety level.

16. The method of claim 11, further comprising updating the parameters of the neural network by continuous learning based on driving situations encountered by the ego.

17. The method of claim 16, wherein the loss function comprises parameters, further comprising updating the parameters of the loss function based on the driving situations encountered by the ego.

18. A system for determining a trajectory of an autonomous vehicle, the system comprising:
a memory;
a processor; and
a trajectory determination module, comprising a neural network, the trajectory determination module stored in the memory and configured to determine the trajectory by causing the processor to perform the steps of:
generating a graph comprising:
an ego node corresponding to an autonomous vehicle (ego),
a plurality of virtual nodes, each corresponding to a possible movement of the ego, and
a plurality of ego-virtual edges, each connecting the ego node to a respective virtual node of the plurality of virtual nodes; and
for a predefined number of time steps, performing the steps of:
providing the graph as input to a neural network trained to generate a vector corresponding to a plurality of weights, each weight of the plurality of weights being associated to a respective virtual node of the plurality of virtual nodes,
computing from the plurality of weights a vector corresponding to a movement of the ego, and
updating the graph to account for a new position of the ego computed based on the movement of the ego,
wherein a trajectory is defined by subsequent positions of the ego.

19. The system of claim 18, further comprising a controller configured to provide control signals to an autonomous vehicle to drive the autonomous vehicle according to the trajectory.

20. A non-transitory computer-readable medium having instructions stored thereon which, when executed by one or more processors, cause the one or more processors to perform the steps of:
generating a graph comprising:
an ego node corresponding to an autonomous vehicle (ego),
a plurality of virtual nodes, each corresponding to a possible movement of the ego, and
a plurality of ego-virtual edges, each connecting the ego node to a respective virtual node of the plurality of virtual nodes; and
for a predefined number of time steps, performing the steps of:
providing the graph as input to a neural network trained to generate a vector corresponding to a plurality of weights, each weight of the plurality of weights being associated to a respective virtual node of the plurality of virtual nodes,
computing from the plurality of weights a vector corresponding to a movement of the ego, and
updating the graph to account for a new position of the ego computed based on the movement of the ego,
wherein a trajectory is defined by subsequent positions of the ego.
